(19) United States
(12) Patent Application Publication
(10) Pub. No.: US 2017/0148068 A1
(43) Pub. Date: May 25, 2017

(54) ENTITY BASED CONTENT DISTRIBUTION

(71) Applicant: Google Inc., Mountain View, CA (US)

(72) Inventors: Rio Akasaka, Mountain View, CA (US); Etienne Deguine, San Francisco, CA (US); Zhen Yu, Shanghai (CN)

(21) Appl. No.: 15/309,614

(22) PCT Filed: May 9, 2014
(86) PCT No.: PCT/CN2014/077155

§ 371 Date: Nov. 8, 2016

(51) Int. Cl. G06Q 30/02; H04L 29/08

(52) U.S. Cl. CPC G06Q 30/0277; H04L 67/32

(57) ABSTRACT

Methods, systems, and apparatus, including computer programs encoded on a computer storage medium, for distributing content are disclosed. In one aspect a distribution phrase that is used to distribute a content item for a content sponsor is accessed. Entities that correspond to the distribution phrase are identified and data specifying the entities are provided to the content sponsor. Data specifying at least one of the entities to be used as an entity distribution parameter for the content item are received from the content sponsor. A content item request that includes a resource identifier is received. A determination is made based, at least in part, on the resource identifier, that the resource references the at least one of the entities. The content item is distributed in response to the determination that the resource references the at least one of the entities.

### BACKGROUND

This specification relates to data processing content distribution parameters.

The Internet provides access to a wide variety of resources. For example, video and/or audio files, as well as web pages for particular subjects or that present particular news articles are accessible over the Internet. Access to these resources presents opportunities for advertisements (or other sponsored content items) to be provided with the resources. For example, a web page can include “slots” (i.e., specified portions of the web page) in which advertisements (or other content items) can be presented. These slots can be defined in the web page or defined for presentation with a web page, for example, in a separate browser window. Advertisements or other content items that are presented in slots of a resource are selected for presentation by a content distribution system.

### SUMMARY

In general, one innovative aspect of the subject matter described in this specification can be embodied in methods that include the actions of accessing a distribution phrase that is used to distribute a content item for a content sponsor; identifying, based on the distribution phrase, one or more entities that correspond to the distribution phrase; providing, for presentation to the content sponsor, data specifying the one or more entities as one or more candidate distribution parameters for distributing the content item; receiving data specifying at least one of the one or more entities to be used as an entity distribution parameter for the content item; receiving a content item request that includes a resource identifier corresponding to a resource; determining, based on the resource identifier, that the resource references the at least one of the one or more entities corresponding to the entity distribution parameter; and distributing, based on the determination that the resource references the at least one of the one or more entities corresponding to the entity distribution parameter, the content item in response to the request. Other embodiments of this aspect include corresponding systems, apparatus, and computer programs, configured to perform the actions of the methods, encoded on computer storage devices.

These and other embodiments can each optionally include one or more of the following features. Identifying one or more entities that correspond to the distribution phrase can include determining that the distribution phrase refers to two different entities. Providing data specifying the one or more entities as candidate distribution parameters can include providing data requesting the content sponsor to select one of the two different entities as the entity distribution parameter for the content item.

Methods can further include the actions of providing, with the data specifying one or more entities as candidate distribution parameters, code that causes presentation of a user interface element that requests an entity information resource in response to user interaction with the user interface element, the entity information resource including information about one of the two different entities.

Receiving data specifying at least one of the one or more entities as candidate distribution parameters can include receiving, based on input by the content sponsor, a multi-entity distribution parameter that will be used to distribute the content item and that specifies two entities and a connective operator representing a relationship between the two entities. Determining that the resource references the at least one of the one or more entities can include determining that a set of entities associated with the resource identifier satisfies the multi-entity distribution parameter.

Receiving data specifying at least one of the entities to be used as a distribution parameter for the content item can include receiving data identifying the at least one entity and a related entities identifier. Methods can further include the actions of identifying related entities that are related to the at least one entity in a manner specified by the related entities identifier.

Determining that the resource references the at least one of the one or more entities can include determining that the resource references one of the related entities. Distributing the content item in response to the request can include distributing the content item based on the determination that the resource references the one of the related entities.

Receiving the related entities identifier can include receiving a relationship indicator specifying a relationship that related entities must have relative to the at least one entity and a degree of separation the at least one entity that related entities must have relative to the at least one entity. Identifying the related entities can include identifying entities that have the specified relationship relative to the at least one entity and are within the specified degree of separation of the at least one entity.

Particular embodiments of the subject matter described in this specification can be implemented so as to realize one or more of the following advantages. Content sponsors are provided suggestions for distributing content with resources based on the entities that the resources reference, thereby enabling selectively distributing content among two pages that may reference different entities that share a same name. Content sponsors can also expand a set of resources with which the content item is presented by specifying additional (e.g., related) entities for purposes of distributing content. Content distribution parameters can be combined using connective operator to more specifically identify types of resources with which content is eligible for presentation.

### BRIEF DESCRIPTION OF THE DRAWINGS

FIG. 1 is a block diagram of an example environment in which content is distributed to user devices.

FIG. 2 is a block diagram of an example data flow for suggesting entity distribution parameters to a content sponsor.

FIG. 3 is a screen shot of an example user interface for suggesting entity distribution parameters to a content sponsor.

FIG. 4 is a block diagram of an example process for distributing content items based on entity distribution parameters.

FIG. 5 is block diagram of an example computer system.

Like reference numbers and designations in the various drawings indicate like elements.

### DETAILED DESCRIPTION

Entity distribution parameters are suggested to content sponsors based, at least in part, on distribution phrases (e.g., one or more keywords) that are used to distribute content items (e.g., advertisements) provided by the content sponsor. In some implementations, the entity distribution parameters specify one or more entities that must be referenced by a resource in order for the content item to be eligible for presentation with the resource. As used throughout this document an entity is a particular identifiable person (e.g., a celebrity), place (e.g., national park), thing (e.g., ice cream), or concept (e.g., biology), and can be associated with an entity identifier (e.g., a set of characters) that uniquely identify the entity with respect to other entities. As discussed in more detail below, relationships between entities can be mapped in a knowledge graph to facilitate identification of entities that are related to other entities as well as the nature of the relationships between the entities.

A distribution phrase can be used to identify a particular entity in the knowledge graph (e.g., based on a matching name between the entities), and the particular entity can be identified as an entity distribution parameter (or a candidate entity distribution parameter) for the content item. Other entities can also be identified as candidate entity distribution parameters based on their relationships to the particular entity. For example, other entities that have a direct relationship relative to the particular entity (e.g., are directly linked to the particular entity in the knowledge graph) may be identified as candidate entity distribution parameters for the content item. As discussed in more detail below, additional entities (e.g., entities that share a same relationship as the particular entity relative to another entity) can also be identified as candidate entity distribution parameters for the content item.

The candidate entity distribution parameters can be suggested to the content sponsor, and the content sponsor can select one or more of the candidate entity distribution parameters as entity distribution parameters for the content item. In turn, the content item can be distributed for presentation with resources that reference entities corresponding to the entity distribution parameters for the content item.

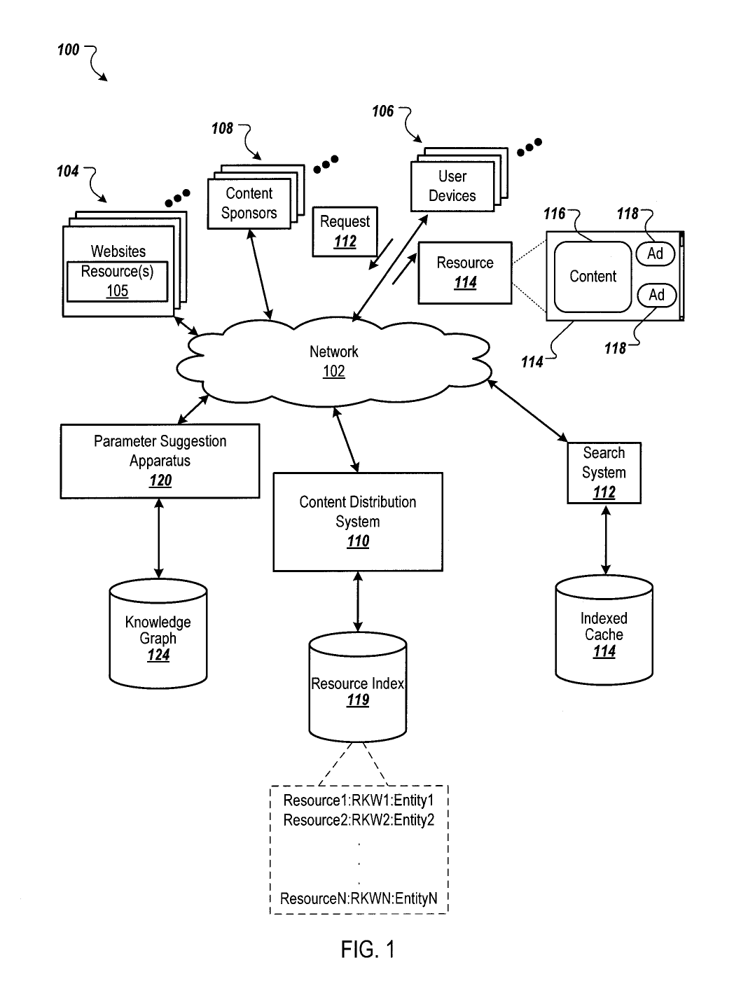

FIG. 1 is a block diagram of an example environment 100 in which content is distributed to user devices 106. The example environment 100 includes a network 102, such as a local area network (LAN), a wide area network (WAN), the Internet, or a combination thereof. The network 102 connects websites 104, user devices 106, content sponsors 108, and a content distribution system 110. The example environment 100 may include many different websites 104, user devices 106, and content sponsors 108.

A website 104 is one or more resources 105 associated with a domain name and hosted by one or more servers. An example website is a collection of web pages formatted in hypertext markup language (HTML) that can contain text, images, multimedia content, and programming elements, such as scripts. Each website 104 is maintained by a publisher, which is an entity that controls, manages and/or owns the website 104.

A resource 105 is any data that can be provided over the network 102. A resource 105 is identified by a resource address that is associated with the resource 105. Resources include HTML pages, word processing documents, and portable document format (PDF) documents, images, video, and feed sources, to name only a few. The resources can include content, such as words, phrases, images and sounds, that may include embedded information (such as meta-information in hyperlinks) and/or embedded instructions (such as scripts). Units of content that are presented in (or with) resources are referred to as content items.

A user device 106 is an electronic device that is capable of requesting and receiving resources over the network 102. Example user devices 106 include personal computers, mobile communication devices, and other devices that can send and receive data over the network 102. A user device 106 typically includes a user application, such as a web browser, to facilitate the sending and receiving of data over the network 102.

A user device 106 can submit a resource request 112 that requests a resource 105 from a website 104. In turn, data representing the requested resource 114 can be provided to the user device 106 for presentation by the user device 106. The requested resource 114 can be, for example, a home page of a website 104, web page from a social network, a video from a video sharing site, or another resource 105. The data representing the requested resource 114 can include data that cause presentation of resource content 116 at the user device 106.

The data representing the requested resource 114 can also include data specifying a portion of the resource (e.g., a portion of a web page) or a portion of a user display (e.g., a presentation location of another window or in a slot of a web page) in which content items, such as advertisements, can be presented. Throughout this document, these specified portions of the resource or user display are referred to interchangeably as content items slots or advertisement slots 118. Any type of content (e.g., content items other than advertisements) can be presented in these advertisement slots 118. For purposes of example, the advertisements slots 118 will be discussed with reference to slots on a web page. However, the advertisements slots 118 can be slots of time during presentation of a video (or other dynamic content) in which a video advertisement or another content item can be presented.

When a resource 105 is requested by a user device 106, execution of code associated with an advertisement slot 118 in the resource initiates a request 112 for an advertisement (or another type of content item) to populate the advertisement slot 118. The request 112 can include characteristics of the advertisement slots 118 that are defined for the requested resource 114. For example, a reference (e.g., URL or resource identifier) to the requested resource 114 for which the advertisement slot 118 is defined, a size of the advertisement slot 118 (or a duration of an advertisement slot in a video), and/or media types that are eligible for presentation in the advertisement slot 118 can be provided to the content distribution system 110. Keywords associated with a requested resource (“resource keywords”) or entities that are referenced by the resource can be used by the content distribution system 110 to facilitate identification of advertisements that are considered relevant to the requested resource 114.

The advertisements (or other content items) that are provided in response to an advertisement request 112 (or another content item request) are selected based on distribution parameters for the advertisements. Distribution parameters are a set of parameters upon which distribution of content items are conditioned. In some implementations, the distribution parameters for a particular advertisement (or other content item) can include distribution phrases (e.g., one or more keywords) that must be matched (e.g., by resource keywords) in order for the advertisement to be eligible for presentation. The distribution criteria can also specify a bid and/or budget for distributing the particular advertisement. Bids are used to conduct an auction to select which advertisement(s) will be presented and/or in which advertisement slot the advertisement(s) will be presented. A content item provider can specify a budget, which will limit the maximum amount that the content item provider will spend over a specified period.

Keywords or entities that are referenced by a resource can be stored, for example, in a resource index 119. For example, as illustrated in FIG. 1, the resource index 119 can include a list of resources (e.g., Resource1, Resource2, . . . , ResourceN), keywords that are related to each of the resources (e.g., RKW1, RKW2, . . . , RKWN), and entities that are referenced by each of the resources (e.g., Entity1, Entity2, . . . , EntityN). The keywords or entities that are associated with each resource in the resource index 119 can be specified by publishers of the resource or determined based on content that is associated with each of the resources. For example, a user that submits a video to a video sharing site can specify one or more entities that are related to the video and/or one or more keywords that are related to the subject matter of the video. In a particular example, the user may specify one or more actors that are included in the video, one or more products that are in the video, or other entities that are related to the video (e.g., a producer of the video, a title of the video, or other information).

In some implementations, keywords or entities that are associated with (or referenced by) a resource can be determined based on the content of the resource or content of other resources that reference (e.g., link to or discuss) the resource. For example, assume that a referring site includes a link to a particular video (or web page). In this example, the content of the referring site can be evaluated to identify one or more entities or topics referenced in the content of the referring site, and then the entities or topics can be associated with the particular video (or web page). For example, one or more of these entities or topics can be stored in the resource index 119 in association with (e.g., with a reference to) the particular video (or web page).

When a content item request 112 is received, the content distribution system 110 can access the resource index 119 using a resource identifier (e.g., that uniquely identifies the resource) to identify the keywords and/or entities that have been deemed related to the resource corresponding to the request. In turn, the content distribution system 110 can identify those content items having distribution parameters (e.g., specified keywords or specified entities) that are matched by the keywords and/or entities that are associated with the resource. The content distribution system 110 selects one or more of the identified content items for distribution in response to the request based, at least in part, on bids corresponding to the identified content items.

Entity based distribution of content items provides a content sponsor the ability to pinpoint a particular person, place, thing, or concept that a resource must reference in order for a content item to be distributed for presentation with the resource. As discussed in more detail below, entity based distribution of content items also enables a content sponsor to identify entities that are related to, but different from, a particular entity for purposes distributing its content with resources that may not be directly about the particular entity, but include content to entities that are related to the particular entity.

For purposes of illustration, assume that a content sponsor wants to distribute content items to users that are interested in action/adventure movies. In this example, the content sponsor may use the distribution phrases (e.g., keywords) “movie,” “action movie,” or “adventure” as distribution parameters for its content items. These distribution phrases may cause the content sponsor's content items to be eligible for distribution in response to any resource request that is associated with a resource having a resource keyword that matches one or more of “movie,” “action movie,” or “adventure.” In this example, the content sponsor could more specifically indicate the eligibility of its content items by specifying one or more entities (e.g., movie titles, actors, directors, production studios, or other related entities) that a resource must be associated with in order for the content item to be distributed for presentation with the resource.

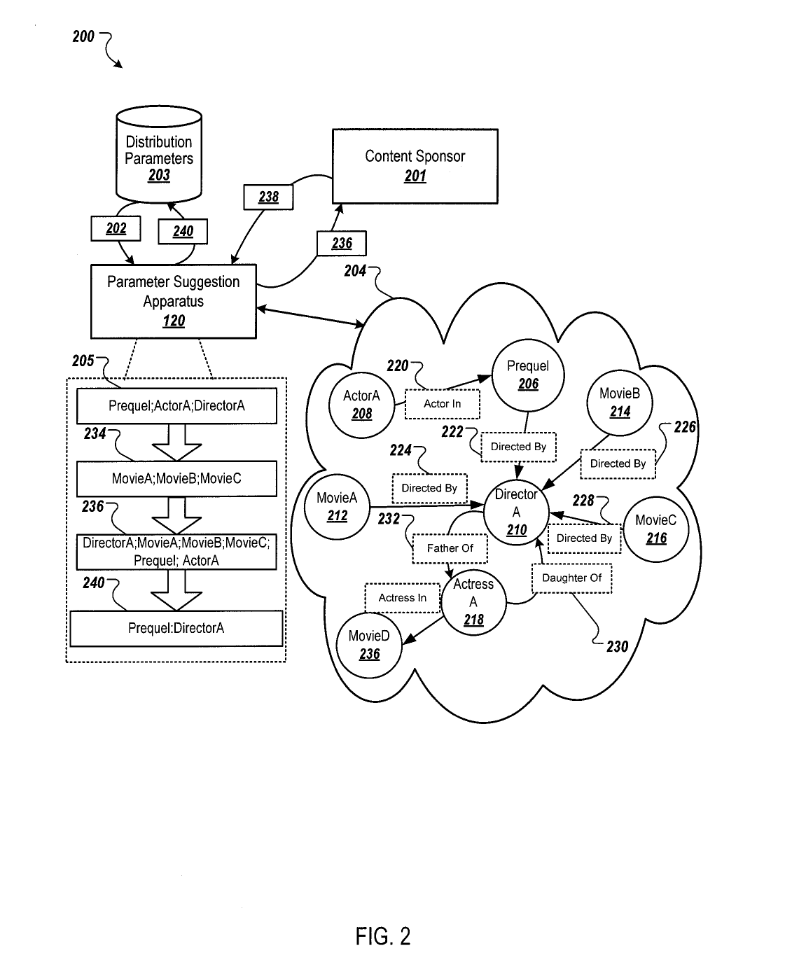

The environment 100 includes a parameter suggestion apparatus 120 that can suggest entities to be used as distribution parameters for content items. The parameter suggestion apparatus 120 is a data processing apparatus that utilizes distribution phrases (e.g., one or more keywords) to identify entities associated with the distribution phrases and suggest one or more of the entities as entity distribution parameters for a content item. As discussed in more detail with reference to FIG. 2, the parameter suggestion apparatus 120 uses a knowledge graph 124 to identify the entities associated with the distribution phrases. The parameter suggestion apparatus 120 can also navigate the knowledge graph to identify other entities related to the identified entities and suggest one or more of those other entities as entity distribution parameters for the content item, as discussed below with reference to FIG. 2.

FIG. 2 is a block diagram of an example data flow 200 for suggesting entity distribution parameters to a content sponsor 201. The data flow 200 begins with the parameter suggestion apparatus 120 accessing (or receiving) distribution parameters 202 that are used to distribute a content item for a content sponsor 201. The distribution parameters 202 can be received, for example, from a distribution parameter data store 203. In some implementations, the distribution parameters 202 include a distribution phrase (e.g., one or more keywords) that is used to distribute the content item. For example, assume that the distribution parameters 202 include the distribution phrase “Prequel,” which refers to a title of a movie.

The parameter suggestion apparatus 120 can access a knowledge graph 204 to identify a set of entities 205 that correspond to the distribution phrase “Prequel,” and use the identified set of entities 205 to suggest entity distribution parameters to the content sponsor 201. For example, based on the match between the distribution phrase “Prequel” and the title of the entity Prequel, represented by node 206, the parameter suggestion apparatus 120 can identify the entity represented by node 206 as an entity that corresponds to the distribution phrase “Prequel.”

As used in this document, a knowledge graph is a representation of relationships between unique entities, and the knowledge graph can be stored in one or more data stores. The knowledge graph can be implemented, for example, in graphical form or in a data structure that includes data representing each node and data representing the relationships between each node.

Each node in the knowledge graph 204 represents a different entity and pairs of nodes in the knowledge graph are connected by relationship paths (e.g., graph edges) that indicate a relationship between the two entities represented by the pair of nodes. For example, the knowledge graph 204 includes node 206 representing the prequel, node 208 representing ActorA, node 210 representing DirectorA, nodes 212, 214, and 216 that respectively represent MovieA, MovieB, and MovieC, and node 218 representing ActressA. Node 206 and node 208 are connected by a relationship path 220 indicating that ActorA is an actor in the prequel. Node 210, representing DirectorA, is connected to each of node 206, 212, 214, and 216 by relationship paths 222, 224, 226, and 228 indicating that DirectorA is the director of each of the prequel, MovieA, MovieB, and MovieC.

A single pair of nodes can have multiple different relationship paths that connect the pair of nodes. For example, node 218, which represents ActressA, is connected to node 210, which represents DirectorA, by relationship path 230 indicating that ActressA is the daughter of DirectorA, and by relationship path 232 indicating that DirectorA is the father of ActressA. If additional relationships were identified between DirectorA and ActressA additional relationship paths could be used to represent these relationships.

Using the relationships specified by the knowledge graph 204, the parameter suggestion apparatus 120 can identify other entities that may also correspond to the distribution phrase “Prequel.” In some implementations, the parameter suggestion apparatus 120 can include in the set of entities 205 one or more entities that have a direct relationship with the entity that was identified using the distribution phrase. For example, as illustrated by FIG. 2, ActorA, represented by node 208, has the direct relationship of “actor in” with node 206, which was identified based on the distribution phrase. Similarly, DirectorA, represented by node 210, has the direct relationship of “directed by” with node 206. In this example, the parameter suggestion apparatus 120 can use these direct relationships relative to node 206 as a basis for identifying ActorA and DirectorA as entities corresponding to the distribution phrase “Prequel.” As discussed in more detail below the entities that are identified as corresponding to the distribution phrase can be identified to a content sponsor 201 as candidate distribution parameters for a content item.

In some implementations, the parameter suggestion apparatus 120 can use other relationships specified in the knowledge graph 204 to identify a set of additional entities 234 that can be suggested to the content sponsor 201 as candidate distribution parameters for the content item. For example, in response to determining that DirectorA, represented by node 210, has a direct relationship of “directed by” with node 206, representing the movie Prequel, the parameter suggestion apparatus 120 can identify, as entities corresponding to the distribution phrase “Prequel” other entities that also have the direct relationship “directed by” with node 210, which represents DirectorA. In this example, the parameter suggestion apparatus 120 can identify MovieA, MovieB, and MovieC as entities corresponding to the distribution phrase “Prequel” based on the fact that nodes 212, 214, and 216, which respectively represent entities MovieA, MovieB, and MovieC, also have the direct relationship of “directed by” with DirectorA. As such, the parameter suggestion apparatus 120 can include the entities MovieA, MovieB, and MovieC in the set of additional entities 234, which can be used to suggest candidate distribution parameters to the content sponsor 201.

Note that various relationships, either direct or indirect, can be used to identify entities that correspond to the distribution phrase. In some implementations, the degree of separation between an entity that is directly identified using the distribution phrase (e.g., the Prequel entity 206) and other entities that are considered to correspond to the distribution phrase can be specified by an administrator of the parameter suggestion apparatus and/or the content sponsor 201. For example, the content sponsor 201 can be provided the ability to specify a maximum number of degrees of separation that entities must be within (e.g., relative to an initially identified entity, such as the Prequel entity 206) in order for the entity to be eligible for inclusion in a set of candidate distribution parameters that are suggested to the content sponsor 201.

For purposes of illustration, assume that the maximum number of degrees of separation between the initially identified entity (e.g., Prequel 206) and other entities that are eligible to be suggested as candidate distribution parameters is set to 2.0. In this example, the entity MovieD, represented by node 236, would not be eligible to be suggested as a candidate distribution parameter (e.g., would not be eligible to be included in the set of entities 205 or the set of additional entities 234) because it is three degrees of separation relative to Prequel, represented by node 206, which exceeds the maximum number of degrees of separation.

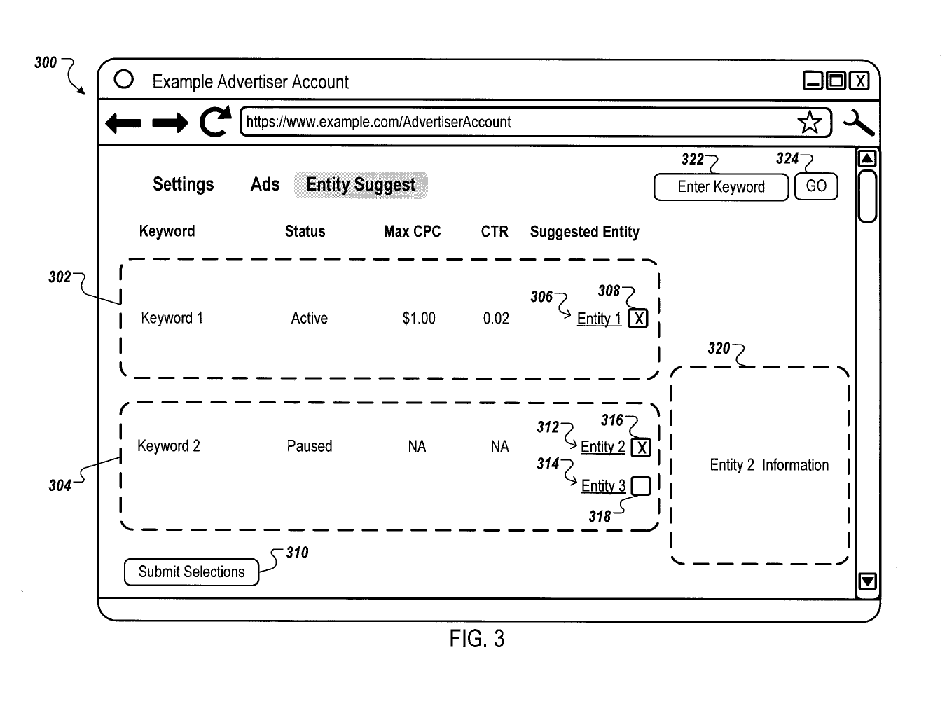

The parameter suggestion apparatus 120 can combine the set of entities 205 and the set of additional entities 234 into a set of candidate distribution parameters 236 that is provided to the content sponsor 201. As discussed in more detail with respect to FIG. 3, the content sponsor 201 is provided the ability to select which of the candidate distribution parameters 236 are to be used as entity distribution parameters for the content item (e.g., distribution parameters specifying entities that when referenced by a resource will cause the content item to be eligible for distribution with the resource).

For example, the content sponsor can submit data 238 specifying a set of distribution entities 240 from the set of candidate entities 236 that are to be used as entity distribution parameters for the content item. For purposes of illustration, assume that the content sponsor selected the Prequel and DirectorA as the set of distribution entities 240 that are to be used as entity distribution parameters for the content item. In this example, the parameter suggestion apparatus 120 can use the set of distribution entities 240 specified by the content sponsor to store entity distribution parameters for the content item in the distribution parameter store 203.

FIG. 3 is a screen shot of an example user interface 300 for suggesting entity distribution parameters to a content sponsor. The user interface 300 includes an entity suggest area 302 for “Keyword 1,” which is a distribution phrase for a content item (or group of content items), and another entity suggest area 304 for “Keyword 2,” which is another distribution phrase for the content item (or group of content items).

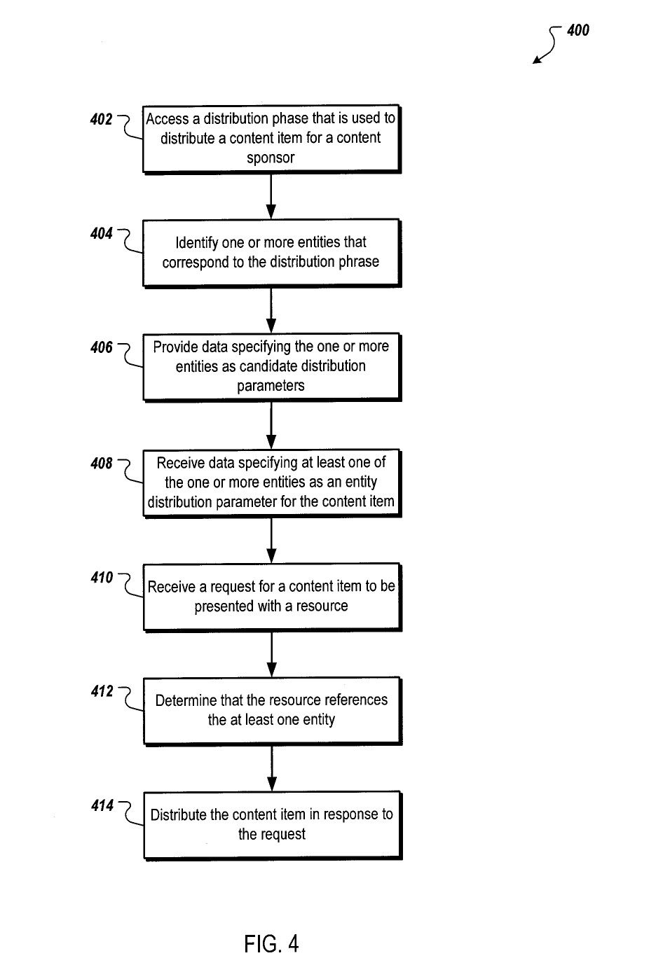

In the entity suggest area 302, the user interface 300 provides information identifying “Keyword 1,” information specifying that the status of “Keyword 1” is active (e.g., that “Keyword 1” is being used to distribute the content item), information specifying the maximum bid (e.g., “Max CPC” (or Cost-per-Click) associated with “Keyword 1”), the click through rate (“CTR”) for content items distributed using “Keyword 1,” as well as information specifying a candidate entity 306 (e.g., Entity 1) for “Keyword 1.” The candidate entity 306 can be identified from a knowledge graph, for example, using “Keyword 1” in a manner similar to that discussed above with respect to FIG. 2, and further discussed below with respect to FIG. 4.

The entity suggest area 302 includes a user interface element 308 (e.g., a check box) that enables the content sponsor to specify whether the candidate entity 306 is to be used as an entity distribution parameter for the content item (or group of content items) that are currently being distributed using “Keyword 1.” After interacting with (e.g., clicking) the user interface element 308 to check the user interface element 308, the content sponsor can interact with (e.g., click) the “Submit Selections” interface element 310 to specify that the candidate entity 306 is to be used as an entity distribution parameter for the content item (or group of content items.

In the entity suggest area 304, the user interface 300 provides information identifying “Keyword 2,” information specifying that the status of “Keyword 2” is paused (e.g., that “Keyword 2” is not currently being used to distribute the content item), information specifying the maximum bid (e.g., “Max CPC” associated with “Keyword 2”), the click through rate (“CTR”) for content items distributed using “Keyword 2,” as well as information specifying candidate entities 312 and 314 (e.g., Entity 2 and Entity 3) for “Keyword 2.” The candidate entities 312 and 314 can be identified from a knowledge graph, for example, using “Keyword 2” in a manner similar to that discussed above with respect to FIG. 2, and further discussed below with respect to FIG. 4.

In some implementations, the candidate entity 312 (Entity 2) may be an entity that has been directly identified using “Keyword 2” in a manner similar to that by which the movie Prequel was identified based on the distribution phrase “Prequel.” Similarly, the candidate entity 314 (Entity 3) can be an entity that was identified as having a direct (or indirect) relationship with the candidate entity 312. Referring back to the example discussed with reference to FIG. 2, the candidate entity 314 could be the entity DirectorA, ActorA, or one of MovieA, MovieB, or MovieC.

In some implementations, the candidate entities 312 and 314 may be two entities that could potentially be referred to by “Keyword 2.” For example, assume that “Keyword 2” is a phrase that refers to a type of animal as well as the name of an automobile company. In this example, the particular entity to which “Keyword 2” is referring may not be immediately determined based on “Keyword 2,” alone. In such a situation, one option is to identify both the type of animal and the automobile company as two candidate entities, and allow the content sponsor to resolve the ambiguity by selecting the appropriate entity from the candidate entities 312 and 314. For example, the content sponsor may specify that the entity of interest (e.g., referred to by “Keyword 2”) is the type of animal by interacting with the user interface element 316, and may specify that the entity of interest is the automobile company by interacting with the user interface element 318.

In some implementations, the text (or other user interface elements) identifying the candidate entities 306, 312, and/or 314 can each include a hyperlink to a respective entity information resource that provides information about the respective candidate entity. For example, the content sponsor can interact with (e.g., click) the text “Entity 2” to initiate a request for an entity information resource (e.g., web page) that provides information about Entity 2.

The entity information resource can be presented, for example, in an entity information portion 320 of the user interface 300, presented in a separate browser window, or otherwise presented in response to the interaction with the text “Entity 2.” Similarly, interaction with the text “Entity 1” can initiate a request for an entity information resource that provides information about Entity 1 and interaction with the text “Entity 3” can initiate a request for an entity information resource that provides information about Entity 3. The access to the entity information resources can help a content sponsor determine which of the entities that they would like to use as entity distribution parameters for a content item.

The user interface 300 also includes an entity search interface 322 that enables a content sponsor to enter keywords (or distribution phrases) and receive a list of entities that are related to the entered keywords. For example, the entity search interface 322 can accept a keyword entered by the content sponsor, and upon detecting interaction with the “Go” button 324 can identify one or more entities related to the keyword (e.g., in a manner similar to that discussed above with reference to FIG. 2). In turn, the entities that were identified based on the keyword can be presented in the user interface 300 in a manner similar to that discussed with reference to the candidate entities 306, 312, and 314.

FIG. 4 is a flow chart of an example process 400 for distributing content items based on entity distribution parameters. The process 400 can be implemented, for example, using one or more data processing apparatus, such as the parameter suggestion apparatus 120 and/or the content distribution system 110 of FIG. 1. The process 400 can also be implemented using instructions stored on a non-transitory computer readable medium, where the instructions cause one or more data processing apparatus to perform operations of the process 400.

A distribution phrase is accessed (402). In some implementations, the distribution phrase is one or more terms, or keywords, that are used to distribute a content item for a content sponsor. For example, as discussed above, the distribution phrase can be a keyword that is being used to distribute an advertisement or another content item with web pages or other resources.

One or more entities that correspond to the distribution phrase are identified (404). In some implementations, the one or more entities that correspond to the distribution phrase can be identified using the distribution phrase to identify one or more entities from a knowledge graph. As discussed above with respect to FIG. 2, an initial entity that corresponds to the distribution phrase can be an entity that has a name matching the distribution phrase. For example, as discussed with reference to FIG. 2, the distribution phrase “Prequel” was used to identify an entity (e.g., a movie named Prequel) in the knowledge graph. In this example, it is assumed that only a single entity had a name matching the distribution phrase or that other available contextual data (e.g., the distribution phrase “movie” also being used to distribute the content item) allowed the Prequel movie to be identified, from among other entities sharing the name Prequel, as the initial entity corresponding to the distribution phrase.

In some implementations, a set of entities that are identified as corresponding to the distribution phrase includes two or more different entities. For example, as discussed above with respect to FIG. 3, it may be that a particular distribution phrase matches a name of two different entities. In this example, each of the two entities could be identified from the knowledge graph using the distribution phrase.

In another example, additional entities that are related, in the knowledge graph, to an entity identified using the distribution phrase can be identified as corresponding to the distribution phrase. As discussed above with respect to FIG. 2, the additional entities can include entities that have a direct relationship with (e.g., one degree of separation relative to) an entity identified using the distribution phrase.

Alternatively, or additionally, the additional entities can also include other entities that do not have a direct relationship with an entity identified using the distribution phrase. For example, as discussed above with respect to FIG. 2, the entities MovieA, MovieB, and MovieC were identified as corresponding to the distribution phrase based on the fact that each of these entities had the relationship “directed by” with DirectorA, which is the same relationship that the Prequel entity had with DirectorA. Thus, relationships that are shared among entities can be used for purposes of identifying entities that correspond to the distribution phrase.

Data specifying the one or more entities as candidate distribution parameters are provided to the content sponsor (406). As discussed above, with reference to FIG. 2, the data can cause presentation in a user interface of information specifying the entities that correspond to one or more different distribution phrases as candidate distribution parameters for one or more content items. For example, as illustrated in FIG. 2, the data can cause presentation of a suggested entity (e.g., Entity 1) for one distribution phrase (e.g., Keyword 1) and cause presentation of two (or more) suggested entities (e.g., Entity 2 and Entity 3) for another distribution phrase (e.g., Keyword 2).

As discussed above, the data provided can identify, for a single distribution phrase, multiple entities that correspond to the distribution phrase. Therefore, the data that are provided can include data that cause presentation, in the user interface, of information requesting that the content sponsor select one (or more) of the entities as the entity distribution parameter for the content item. For example, if the distribution phrase could directly refer to multiple different entities (e.g., a type of animal or an automobile manufacturer), the data could cause presentation of information requesting that the content sponsor clarify which of the entities is referenced by their distribution phrase. In another example, the data can cause presentation of a user interface element that enables the content sponsor to select any (or all) of the entities as candidate distribution parameters for the content item.

The data provided can also include code that causes presentation of a user interface element that requests an entity information resource in response to user interaction with the user interface element. For example, as discussed above with reference to FIG. 2, the code can initiate a request for the entity information resource (e.g., web page) in response to a user clicking on the text identifying the entity. In response to the request, the entity information resource can be obtained and presented to provide the content sponsor with information about the entity corresponding to the user interface element with which the interaction occurred.

Data specifying at least one of the one or more entities as an entity distribution parameter for the content item are received (408). In some implementations, the data specifying the one or more entities are received from the content sponsor, for example, through a user interface similar to that described above with respect to FIG. 2.

In some implementations, the data received from the content sponsor specifying entities as entity distribution parameters for the content item include a multi-entity distribution parameter. The multi-entity distribution parameter is data specifying two or more different entities that will be used to condition distribution of the content item. For example, with reference to FIG. 2, assume that the content sponsor selected Entity 2 and Entity 3 to be entity distribution parameters for a content item. In this example, the multi-entity distribution parameter would be a distribution parameter specifying both Entity 2 and Entity 3 as entity distribution parameters for the content item.

The data specifying the multi-entity distribution parameter also includes a connective operator representing a relationship between the two entities for purposes of conditioning distribution of the content item. In some implementations, the connective operator can be a Boolean operator that specifies one or more combinations of the entities that must be referenced by a resource in order for the content item to be eligible for distribution with the resource. For example, the connective operator could be an “AND,” “OR,” NOT,” or “AND NOT” operator. The connective operators could also include other logical operators, such as XOR or NOR.

When the multi-entity distribution parameter is received with a connective operator, the content item will be eligible for distribution when the expression created using the multi-entity distribution parameter and the connective operator is satisfied. For example, assume that the multi-entity distribution parameter specified Entity 2 as well as Entity 3, and that the connective operator specified AND. In this example, the content item would be eligible for distribution with resources that reference both Entity 1 AND Entity 2.

In some implementations, the data received from the content sponsor specifying an entity to be used as an entity distribution parameter can include data identifying the entity as well as a related entities identifier. The related entities identifier is an identifier specifying a relationship relative to the specified entity that a referenced entity must have for the content item to be distributed with a resource that references to the referenced entity. The entities that are related to the referenced entity in the manner specified by the related entities identifier can be identified, for example, from the knowledge graph and included as entity distribution parameters for the content item.

For purposes of illustration, assume that the data received from the content sponsor identified DirectorA (from FIG. 2) as the entity to be used as the entity distribution parameter for a content item. Also assume that the data received from the content sponsor also included the related entities identifier “directed by.” In this example, the related entities identifier indicates that entities that have the relationship “directed by” relative to the entity DirectorA are also considered to be entity distribution parameters for the content item. Therefore, the content item would be eligible for distribution with resources that are associated with any of the movies Prequel, MovieA, MovieB, or MovieC (e.g., in the resource index 119).

In some implementations, the data received from the content sponsor can also include degree of separation data specifying a maximum degree of separation that an entity must have to another entity (e.g., an entity identified directly from the distribution phrase) in order for that entity to be included in the set of related entities (or as an entity distribution parameter). For example, assume that the degree of separation data specifies that only entities that are within two degrees of separation of the particular entity identified directly from the distribution phrase (e.g., Prequel in FIG. 2), are eligible to be related entities. In this example, only those entities that are within two edges (or links) of the particular entity will be eligible to be a related entity for the content item. Thus, the identification of related entities can be limited to the identification of entities that are within the maximum specified degree of separation.

A request for a content item to be presented with a resource is received (410). In some implementations, the request includes a resource identifier that uniquely identifies the resource. The resource identifier may include, for example, a URL or a pageID that has been assigned to the resource.

A determination that the resource references the at least one entity is made (412). In some implementations, the determination is made, at least in part, based on the resource identifier. For example, as discussed above with reference to FIG. 1, the resource identifier can be used to index one or more entities that are referenced by the resource (e.g., in the resource index 119). Upon receipt of the request, the resource identifier can be used to identify the entry in the index corresponding to the resource with which the content item will be presented and the entities that have been stored in association with that entry. In turn, the entities that are stored in association with the entry can be compared with the entity distribution parameters for the content item, and a determination can be made that there is a match between at least one entity distribution parameter and the entities associated with the entry.

In situations where the entity distribution parameters include a multi-entity distribution parameter and/or a connective operator, the determination that the resource references the at least one entity can include a determination that the resource references a set of entities as required by the multi-entity distribution parameter and/or connective operator. For example, if the multi-entry distribution parameter and the connective operator require both Entity 2 AND Entity 3 to be referenced, the determination can include determining that both Entity 2 and Entity 3 are referenced by the entry in the resource index 119 corresponding to the resource identifier.

Similarly, in situations where the entity distribution parameters include a related entity, the determination can include a determination that the related entity is referenced by the entry in the resource index 119 corresponding to the resource identifier.

The content item is distributed in response to the request (414). For example, the content item (or data identifying the content item) can be provided to a user device in response to the request. In situations where data identifying the content item is provided, the data can include, for example, a network location from which the user device can obtain the content item.

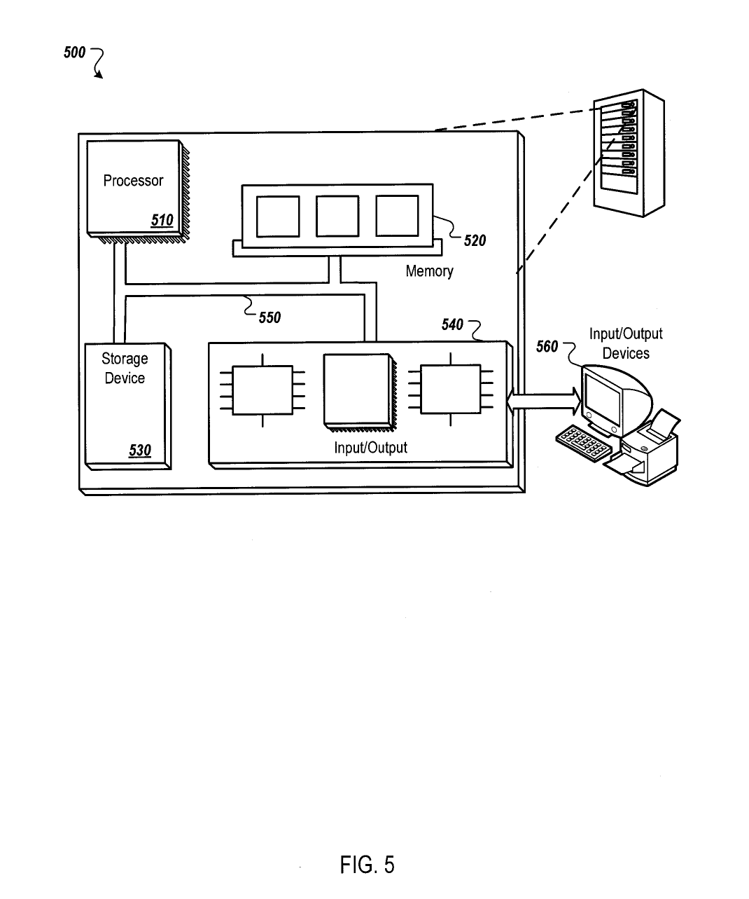

FIG. 5 is a block diagram of an example computer system 500 that can be used to perform operations described above. The system 500 includes a processor 510, a memory 520, a storage device 530, and an input/output device 540. Each of the components 510, 520, 530, and 540 can be interconnected, for example, using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 can include, for example, a hard disk device, an optical disk device, a storage device that is shared over a network by multiple computing devices (e.g., a cloud storage device), or some other large capacity storage device.

The input/output device 540 provides input/output operations for the system 500. In one implementation, the input/output device 540 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 560. Other implementations, however, can also be used, such as mobile computing devices, mobile communication devices, set-top box television client devices, etc.

Although an example processing system has been described in FIG. 5, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by one or more data processing apparatus, the method comprising:
accessing a distribution phrase that is used to distribute a content item for a content sponsor;
identifying, by one or more data processing apparatus and based on the distribution phrase, one or more entities that correspond to the distribution phrase;
providing, for presentation to the content sponsor, data specifying the one or more entities as one or more candidate distribution parameters for distributing the content item;
receiving data specifying at least one of the one or more entities to be used as an entity distribution parameter for the content item;
receiving a content item request that includes a resource identifier corresponding to a resource;
determining, by one or more data processing apparatus and based on the resource identifier, that the resource references the at least one of the one or more entities corresponding to the entity distribution parameter; and
distributing, based on the determination that the resource references the at least one of the one or more entities corresponding to the entity distribution parameter, the content item in response to the request.

2. The method of claim 1, wherein:
identifying one or more entities that correspond to the distribution phrase comprises determining that the distribution phrase refers to two different entities; and
providing data specifying the one or more entities as candidate distribution parameters comprises providing data requesting the content sponsor to select one of the two different entities as the entity distribution parameter for the content item.

3. The method of claim 2, further comprising:
providing, with the data specifying one or more entities as candidate distribution parameters, code that causes presentation of a user interface element that requests an entity information resource in response to user interaction with the user interface element, the entity information resource including information about one of the two different entities.

4. The method of claim 1, wherein:
receiving data specifying at least one of the one or more entities as candidate distribution parameters comprises receiving, based on input by the content sponsor, a multi-entity distribution parameter that will be used to distribute the content item and that specifies two entities and a connective operator representing a relationship between the two entities; and
determining that the resource references the at least one of the one or more entities comprises determining that a set of entities associated with the resource identifier matches the multi-entity distribution parameter.

5. The method of claim 1, wherein receiving data specifying at least one of the entities to be used as a distribution parameter for the content item comprises receiving data identifying the at least one entity and a related entities identifier, the method further comprising:
identifying related entities that are related to the at least one entity in a manner specified by the related entities identifier.

6. The method of claim 5, wherein:
determining that the resource references the at least one of the one or more entities comprises determining that the resource references one of the related entities; and
distributing the content item in response to the request comprises distributing the content item based on the determination that the resource references the one of the related entities.

7. The method of claim 5, wherein:
receiving the related entities identifier comprises receiving a relationship indicator specifying a relationship that related entities must have relative to the at least one entity and a degree of separation the at least one entity that related entities must have relative to the at least one entity; and
identifying the related entities comprises identifying entities that have the specified relationship relative to the at least one entity and are within the specified degree of separation of the at least one entity.

8. A computer storage medium encoded with a computer program, the program comprising instructions that when executed by one or more data processing apparatus cause the one or more data processing apparatus to perform operations comprising:
accessing a distribution phrase that is used to distribute a content item for a content sponsor;
identifying, based on the distribution phrase, one or more entities that correspond to the distribution phrase;
providing, for presentation to the content sponsor, data specifying the one or more entities as one or more candidate distribution parameters for distributing the content item;
receiving data specifying at least one of the one or more entities to be used as an entity distribution parameter for the content item;
receiving a content item request that includes a resource identifier corresponding to a resource;
determining, based on the resource identifier, that the resource references the at least one of the one or more entities corresponding to the entity distribution parameter; and
distributing, based on the determination that the resource references the at least one of the one or more entities corresponding to the entity distribution parameter, the content item in response to the request.

9. The computer storage medium of claim 8, wherein:
identifying one or more entities that correspond to the distribution phrase comprises determining that the distribution phrase refers to two different entities; and
providing data specifying the one or more entities as candidate distribution parameters comprises providing data requesting the content sponsor to select one of the two different entities as the entity distribution parameter for the content item.

10. The computer storage medium of claim 9, wherein the instructions cause the one or more data processing apparatus to perform operations comprising:
providing, with the data specifying one or more entities as candidate distribution parameters, code that causes presentation of a user interface element that requests an entity information resource in response to user interaction with the user interface element, the entity information resource including information about one of the two different entities.

11. The computer storage medium of claim 8, wherein:
receiving data specifying at least one of the one or more entities as candidate distribution parameters comprises receiving, based on input by the content sponsor, a multi-entity distribution parameter that will be used to distribute the content item and that specifies two entities and a connective operator representing a relationship between the two entities; and
determining that the resource references the at least one of the one or more entities comprises determining that a set of entities associated with the resource identifier matches the multi-entity distribution parameter.

12. The computer storage medium of claim 8, wherein:
receiving data specifying at least one of the entities to be used as a distribution parameter for the content item comprises receiving data identifying the at least one entity and a related entities identifier; and
the instructions cause the one or more data processing apparatus to perform operations comprising identifying related entities that are related to the at least one entity in a manner specified by the related entities identifier.

13. The computer storage medium of claim 12, wherein:
determining that the resource references the at least one of the one or more entities comprises determining that the resource references one of the related entities; and
distributing the content item in response to the request comprises distributing the content item based on the determination that the resource references the one of the related entities.

14. The computer storage medium of claim 12, wherein:
receiving the related entities identifier comprises receiving a relationship indicator specifying a relationship that related entities must have relative to the at least one entity and a degree of separation the at least one entity that related entities must have relative to the at least one entity; and
identifying the related entities comprises identifying entities that have the specified relationship relative to the at least one entity and are within the specified degree of separation of the at least one entity.

15. A system comprising:
one or more data storage devices storing instructions executable by one or more data processing apparatus; and
one or more data processing apparatus that interact with the one or more data storage devices and execute instructions that cause the one or more data processing apparatus to perform operations comprising:
accessing a distribution phrase that is used to distribute a content item for a content sponsor;
identifying, based on the distribution phrase, one or more entities that correspond to the distribution phrase;
providing, for presentation to the content sponsor, data specifying the one or more entities as one or more candidate distribution parameters for distributing the content item;
receiving data specifying at least one of the one or more entities to be used as an entity distribution parameter for the content item;
receiving a content item request that includes a resource identifier corresponding to a resource;
determining, based on the resource identifier, that the resource references the at least one of the one or more entities corresponding to the entity distribution parameter; and
distributing, based on the determination that the resource references the at least one of the one or more entities corresponding to the entity distribution parameter, the content item in response to the request.

16. The system of claim 15, wherein:
identifying one or more entities that correspond to the distribution phrase comprises determining that the distribution phrase refers to two different entities; and
providing data specifying the one or more entities as candidate distribution parameters comprises providing data requesting the content sponsor to select one of the two different entities as the entity distribution parameter for the content item.

17. The system of claim 16, wherein the instructions cause the one or more data processing apparatus to perform operations comprising:
providing, with the data specifying one or more entities as candidate distribution parameters, code that causes presentation of a user interface element that requests an entity information resource in response to user interaction with the user interface element, the entity information resource including information about one of the two different entities.

18. The system of claim 15, wherein:
receiving data specifying at least one of the entities to be used as a distribution parameter for the content item comprises receiving data identifying the at least one entity and a related entities identifier; and
the instructions cause the one or more data processing apparatus to perform operations comprising identifying related entities that are related to the at least one entity in a manner specified by the related entities identifier.

19. The system of claim 18, wherein:
determining that the resource references the at least one of the one or more entities comprises determining that the resource references one of the related entities; and
distributing the content item in response to the request comprises distributing the content item based on the determination that the resource references the one of the related entities.

20. The system of claim 18, wherein:
receiving the related entities identifier comprises receiving a relationship indicator specifying a relationship that related entities must have relative to the at least one entity and a degree of separation the at least one entity that related entities must have relative to the at least one entity; and
identifying the related entities comprises identifying entities that have the specified relationship relative to the at least one entity and are within the specified degree of separation of the at least one entity.
